(19) United States
(12) Patent Application Publication
(10) Pub. No.: US 2024/0274859 A1
(43) Pub. Date: Aug. 15, 2024

(54) SECONDARY BATTERY AND MANUFACTURING METHOD OF SECONDARY BATTERY

(71) Applicant: SK On Co., Ltd., Seoul (KR)

(72) Inventors: Moo Hyung LEE, Daejeon (KR); Seong Kook CHOI, Daejeon (KR); Min Woo KANG, Daejeon (KR); Dong Hyuk KIM, Daejeon (KR); Wook Ho SHIN, Daejeon (KR); Sung Wook CHUNG, Daejeon (KR); Kyung Yeon JO, Daejeon (KR); Seong Hyun CHO, Daejeon (KR); In Ung HONG, Daejeon (KR)

(21) Appl. No.: 18/439,263

(22) Filed: Feb. 12, 2024

(30) Foreign Application Priority Data
Feb. 14, 2023 (KR) 10-2023-0019554

(51) Int. Cl. H01M 10/04; H01M 50/103; H01M 50/15; H01M 50/178; H01M 50/30; H01M 50/533; H01M 50/627

(52) U.S. Cl. CPC H01M 10/0431; H01M 10/049; H01M 50/103; H01M 50/15; H01M 50/178; H01M 50/394; H01M 50/533; H01M 50/627

(57) ABSTRACT

A secondary battery according to an embodiment of the present disclosure may include: a cell assembly in which a plurality of electrode assemblies in which a cathode sheet, a separator, and an anode sheet are wound together are stacked; and a pouch exterior material formed to surround the outer circumference of the cell assembly.

### CROSS-REFERENCE TO RELATED PATENT APPLICATION

The present application claims priority under 35 U.S.C. § 119(a) to Korean patent application number 10-2023-0019554 filed on Feb. 14, 2023, in the Korean Intellectual Property Office, the entire disclosure of which is incorporated by reference herein.

### BACKGROUND OF THE INVENTION

### 1. Field

Embodiments of the present disclosure relate to a secondary battery and a manufacturing methods of secondary battery.

### 2. Description of the Related Art

Recently, as the price of energy sources has risen due to the depletion of fossil fuels, and interest in environmental pollution has increased, the demand for eco-friendly alternative energy sources has become an essential factor for future life. Accordingly, research continues on various power production technologies such as nuclear power, solar power, wind power, and tidal power, and power storage devices for using the produced energy more efficiently also continues to draw much attention.

In particular, as technology development and demand for mobile devices increase, the demand for batteries as an energy source is drastically increasing, and accordingly, much research is conducted on batteries that can meet various needs.

Secondary batteries include, for example, nickel cadmium batteries, nickel hydrogen batteries, nickel zinc batteries, and lithium secondary batteries. Among these, lithium secondary batteries are widely used in the field of advanced electronic devices due to their advantages such as free charging and discharging due to little memory effect compared to nickel-based secondary batteries, very low self-discharge rate, high operating voltage, and high energy density per unit weight. In other words, there is high demand for lithium secondary batteries such as lithium-ion batteries and lithium-ion polymer batteries, which have advantages such as high energy density, discharge voltage, and output stability.

According to the shape of the case, secondary batteries may be classified into pouch-type secondary batteries in which the electrode assembly is mounted in a pouch-shaped case of a laminate sheet, and can-type secondary batteries in which the electrode assembly is mounted in a can made of a metallic material. The can in the can-type secondary batteries may be cylindrical or prismatic. In other words, can-type secondary batteries may further be classified into cylindrical batteries and prismatic batteries.

Among them, cylindrical batteries have the advantage of relatively large capacity and structural stability, but due to their external morphological characteristics, it is not easy to arrange them in a stacked structure. In addition, distortion is more likely to occur during charging and discharging than other types of batteries. Prismatic batteries are highly durable and suitable for mass production, whereas they have the disadvantage that the weight is heavy and the heat dissipation is difficult because aluminum cans are used. While pouch-type batteries have the advantage of being light in weight and easy to process, allowing for a variety of shapes, they have the disadvantage that the production costs are higher compared to prismatic and cylindrical batteries.

In addition, secondary batteries are also classified according to the structure of the electrode assembly, in which a cathode, an anode, and a separator interposed between the cathode and the anode are stacked. Typical examples include a jelly roll-type electrode assembly having a structure in which long sheet-shaped cathodes and anodes are wound with a separator interposed therebetween, and a stack-type electrode assembly in which a plurality of cathodes and anodes that are cut into units of a predetermined size are sequentially stacked with a separator interposed therebetween. The jelly roll-type electrode assembly has the advantage of low manufacturing cost and high productivity due to the fast processing speed, but since long sheets are wound, a wasted space may be generated when the sheets are stored in a case, and so the energy density may be low. In addition, there is a possibility that distortion and swelling may occur during long-term charging and discharging.

### SUMMARY OF THE INVENTION

Embodiments of the present disclosure provide a secondary battery that includes a jelly roll-type electrode assembly and that can minimize wasted space when accommodated, and a manufacturing method of secondary battery.

The present disclosure can be widely applied in electric vehicles, battery charging stations, energy storage system (ESS), and the field of green technology, such as photovoltaics, and wind power generation using batteries.

In addition, the present disclosure can be used in eco-friendly mobility including electric vehicles and hybrid vehicles to prevent climate change by suppressing air pollution and greenhouse gas emissions.

A secondary battery according to an embodiment of the present disclosure may include: a cell assembly in which a plurality of electrode assemblies in which a cathode sheet, a separator, and an anode sheet are wound together are stacked; and a pouch exterior material formed to surround the outer circumference of the cell assembly.

According to an embodiment of the present disclosure, the electrode assembly may be a jelly roll-type electrode assembly.

According to an embodiment of the present disclosure, the electrode assembly may include: a cathode tab electrically connected to the cathode sheet and protruding from the electrode assembly; and an anode tab electrically connected to the anode sheet and protruding from the electrode assembly.

According to an embodiment of the present disclosure, the cathode tab and the anode tab may protrude from the electrode assembly in opposite directions.

According to an embodiment of the present disclosure, the cathode tab and the anode tab may protrude from the electrode assembly in same directions.

According to an embodiment of the present disclosure, the cell assembly may include a plurality of electrode assemblies stacked in a direction perpendicular to the direction in which the cathode tab or the anode tab protrudes.

According to an embodiment of the present disclosure, at least one of an end of the pouch exterior material in a direction in which the cathode tab protrudes and an end in a direction in which the anode tab protrudes may be open.

According to an embodiment of the present disclosure, the secondary battery may further include a cap coupled to an open end of the pouch exterior material.

According to an embodiment of the present disclosure, the cap may include an electrode terminal electrically connected to any one of the cathode tab and the anode tab.

According to an embodiment of the present disclosure, the cap may include a gas outlet formed to discharge a gas generated from the inside of the secondary battery.

According to an embodiment of the present disclosure, the cap may include an inlet formed to inject an electrolyte into the secondary battery.

According to an embodiment of the present disclosure, the cell assembly may include a coupling member that couples stacked electrode assemblies to each other.

According to an embodiment of the present disclosure, the cell assembly may include three or more stacked electrode assemblies.

According to an embodiment of the present disclosure, the coupling member may include an insulating material.

A manufacturing method of secondary battery according to an embodiment of the present disclosure may include: a step of stacking a plurality of jelly roll-type electrode assemblies; and a step of surrounding the outer circumference of stacked electrode assemblies with a pouch exterior material.

According to an embodiment of the present disclosure, the electrode assembly may be formed by stacking a cathode sheet, a separator, and an anode sheet, and then winding the same.

According to an embodiment of the present disclosure, the manufacturing method of secondary battery may further include a step of coupling a cap to an open end of the pouch exterior material.

According to the present disclosure, a secondary battery that includes a jelly roll-type electrode assembly and that can minimize wasted space when accommodated, and a manufacturing method of secondary battery are provided, and thus there is the advantage of improving energy density and improving productivity at the same time.

### BRIEF DESCRIPTION OF THE DRAWINGS

FIG. 1 shows a diagram for explaining a secondary battery according to an embodiment of the present disclosure.

FIG. 2 shows a diagram for explaining an electrode assembly included in the secondary battery of FIG. 1.

FIG. 3 shows a diagram for explaining a cap included in the secondary battery of FIG. 1.

FIG. 4 shows a flowchart for explaining a manufacturing method of a secondary battery according to an embodiment of the present disclosure.

FIG. 5 shows a diagram for explaining S100 operation of FIG. 4.

FIG. 6 shows a diagram for explaining S200 operation of FIG. 4.

FIG. 7 shows a diagram for explaining S300 operation of FIG. 4.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

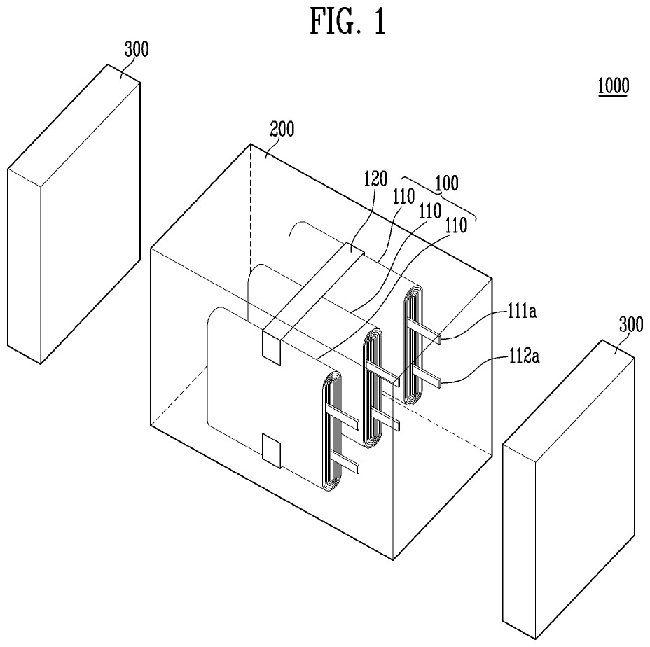

FIG. 1 shows a diagram for explaining a secondary battery according to an embodiment of the present disclosure.

Referring to FIG. 1, a secondary battery 1000 includes a cell assembly 100 and a pouch exterior material 200.

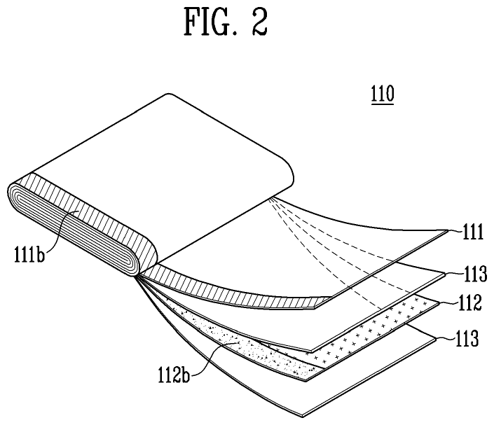

A cell assembly 100 includes a plurality of electrode assemblies 110. More specifically, a cell assembly may include three or more electrode assemblies 110. An electrode assembly 110 may be formed by stacking and winding a cathode sheet, a separator, and an anode sheet. In one embodiment, an electrode assembly 110 may be a jelly roll-type electrode assembly. An electrode assembly 110 will be described in more detail in the description of FIG. 2 below.

A plurality of electrode assemblies 110 in a cell assembly 100 may be stacked on each other. A plurality of stacked electrode assemblies 110 may be coupled to each other by a coupling member 120. In one embodiment, a coupling member 120 may be in the form of an adhesive tape, but it is not limited thereto. In an embodiment, a coupling member 120 may include an insulating material. A coupling member 120 may include an insulating material so that electrode assemblies 110 may be insulated from each other. A coupling member 120 may include, for example, a polyolefin-based polymer, a polyester-based polymer, nylon or the like, but it is not limited thereto.

Electrode assemblies 110 may each include a cathode tab 111a and an anode tab 112a. A cathode tab 111a may be electrically connected to a cathode sheet of an electrode assembly 110. An anode tab 112a may be electrically connected to an anode sheet of an electrode assembly 110. A cathode tab 111a and an anode tab 112a may each be formed to protrude from an electrode assembly 110.

In one embodiment, a cathode tab 111a and an anode tab 112a may each protrude in a same direction from an electrode assembly 110, as shown in FIG. 1.

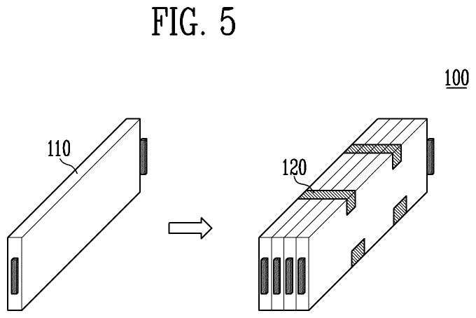

In another embodiment, a cathode tab 111a and an anode tab 112a may each protrude in opposite directions from an electrode assembly 110, as shown in FIG. 5, which will be described later.

In an embodiment, a direction in which a cathode tab 111a and an anode tab 112a each protrude from an electrode assembly 110 may be perpendicular to a direction in which electrode assemblies 110 are stacked within a cell assembly 100.

A pouch exterior material 200 is formed to surround the outer circumference of a cell assembly 100. In an embodiment, a pouch exterior material 200 may be open in one or more of a direction in which a cathode tab 111a protrudes and a direction in which an anode tab 112a protrudes.

In an embodiment, a pouch exterior material 200 may include a polymer material. For example, a polymer material may include one or more materials selected from the group consisting of polyvinyl chloride, polyvinylidene chloride, polyvinylidene fluoride, polymethyl methacrylate, polyamide, polyacrylonitrile, polyvinyl alcohol, poly(ethylene-co-vinyl alcohol), polyethylene terephthalate, polytrimethylene terephthalate, polybutylene terephthalate, nylon 6, nylon 6·6, and polyolefin, but it is not limited thereto. A polyolefin may include one or more selected from the group consisting of low-density polyethylene, linear low-density polyethylene, medium-density polyethylene, high-density polyethylene, a copolymer of ethylene and acrylic acid derivative, polybutene, polyisobutylene, cast polypropylene, biaxially oriented polypropylene, and expandable polypropylene.

In one embodiment, a pouch exterior material 200 may include a polymer layer including the above-described polymer material and a metal layer including a metal. A metal may include one or more selected from iron (Fe), chromium (Cr), manganese (Mn), nickel (Ni), aluminum (Al) or equivalents and alloys thereof, but it is not limited thereto.

In an embodiment, the secondary battery 1000 may further include a cap 300. A cap 300 may be coupled to an open end of a pouch exterior material 200. In one embodiment, when both ends of a pouch exterior material 200 are open as shown in FIG. 1, two caps 300 may be coupled to the open ends of the pouch exterior material 200. In another embodiment, when only one end of a pouch exterior material 200 is open, only one cap 300 may be coupled to the end of the pouch exterior material 200.

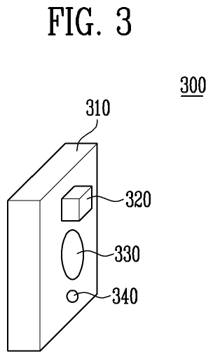

A cap 300 will be described in more detail in the description of FIG. 3 below.

A secondary battery 1000 according to an embodiment of the present disclosure may include a cell assembly 100 in which a plurality of electrode assemblies 110 are stacked, thereby improving energy density. Here, electrode assemblies 110 may be jelly roll-type electrode assemblies, and accordingly, the productivity of a secondary battery 1000 according to an embodiment of the present disclosure may be superior to a case where another type of electrode assemblies are used.

In addition, a secondary battery may include a cell assembly 100 in which jelly roll-type electrode assemblies 110 are stacked, and the cell assemblies 100 may be accommodated in a pouch exterior material made of a polymer material rather than a metal case, thereby minimizing an empty space within the secondary battery 1000. In other words, the degree of cell integration can be improved by maximizing the degree of space utilization, and thus energy density can be further improved.

FIG. 2 shows a diagram for explaining an electrode assembly included in the secondary battery of FIG. 1.

Referring to FIG. 2, an electrode assembly 110 may be a jelly roll-type electrode assembly.

An electrode assembly 110 may include a cathode sheet 111. A cathode sheet 111 may include a cathode active material layer formed by applying a cathode active material slurry including a cathode active material, a binder, and a conductive material to at least one surface of a cathode current collector.

A cathode current collector may include a known conductive material as long as it does not cause a chemical reaction within a lithium secondary battery. For example, a current collector may include any one of stainless steel, nickel (Ni), aluminum (Al), titanium (Ti), copper (Cu), and alloys thereof, and may be provided in various forms such as a film, a sheet, and a foil.

A cathode active material may be a material which lithium (Li) ions may be inserted to and extracted from. A cathode active material may be a lithium metal oxide. For example, a cathode active material is a lithium manganese-based oxide, a lithium nickel-based oxide, a lithium cobalt-based oxide, a lithium nickel manganese-based oxide, a lithium nickel cobalt manganese-based oxide, a lithium nickel cobalt aluminum-based oxide, a lithium iron phosphate-based compound, a lithium manganese phosphate-based compound, a lithium cobalt phosphate-based compound, and a lithium vanadium phosphate-based compound, but it is not necessarily limited to a specific example.

A binder may improve mechanical stability by mediating the bond between a cathode current collector and a cathode active material layer. According to an embodiment, a binder may be an organic binder or an aqueous binder, and may be used with a thickener such as carboxymethyl cellulose (CMC). According to an embodiment, an organic binder may be any one of vinylidene fluoride-hexafluoropropylene copolymer (PVDF-co-HFP), polyvinylidene fluoride (PVDF), polyacrylonitrile, and polymethyl methacrylate, and an aqueous binder may be styrene-butadiene rubber (SBR), but it is not necessarily limited thereto.

A conductive material may improve the electrical conductivity of lithium secondary batteries. A conductive material may include a metal-based material. According to an embodiment, a conductive material may include a conventional carbon-based conductive material. For example, a conductive material may include any one of graphite, carbon black, graphene, and carbon nanotubes. Preferably, a conductive material may include carbon nanotubes.

In addition, a cathode sheet 111 may include a cathode uncoated portion 111b to which a cathode active material slurry is not applied on a cathode current collector. In a cathode uncoated portion 111b, a cathode tab that is electrically connected to a cathode active material layer of a cathode sheet 111 and that protrudes from an electrode assembly 110 may be formed.

An electrode assembly 110 may include an anode sheet 112. An anode sheet 112 may include an anode active material layer formed by applying an anode active material slurry including an anode active material, a binder, and a conductive material to at least one surface of an anode current collector.

An anode current collector may include a known conductive material as long as it does not cause a chemical reaction within a lithium secondary battery. All of the contents described above about a cathode current collector may be applied to an anode current collector.

An anode active material may be a material which lithium ions may be inserted to and extracted from. For example, an anode active material may be any one of carbon-based materials such as crystalline carbon, amorphous carbon, carbon composite, and carbon fiber, lithium alloy, silicon (Si), and tin (Sn). According to an embodiment, an anode active material may be natural graphite or artificial graphite, but it is not limited to a specific example.

A binder may improve mechanical stability by mediating the bond between an anode current collector and an anode active material layer. All of the contents described above about a binder of a cathode sheet 111 may be applied to a binder.

A conductive material may improve the electrical conductivity of lithium secondary batteries. All of the contents described above about a conductive material of a cathode sheet 111 may be applied to a conductive material.

In addition, an anode sheet 112 may include an anode uncoated portion 112b to which an anode active material slurry is not applied on an anode current collector. In an anode uncoated portion 112b, an anode tab that is electrically connected to an anode active material layer of an anode sheet 112 and that protrudes from an electrode assembly 110 may be formed.

In the case of an electrode assembly 110 of the embodiment shown in FIG. 2, since a cathode uncoated portion 111b and an anode uncoated portion 112b are positioned on a same side of a cathode sheet 111 and an anode sheet 112, respectively, a cathode tab and an anode tab may protrude from an electrode assembly 110 in a same direction. In the case of an electrode assembly 110 of another embodiment, a cathode uncoated portion 111b and an anode uncoated portion 112b may be positioned on different side surfaces of a cathode sheet 111 and an anode sheet 112, respectively, and accordingly, a cathode tab and an anode tab may protrude from an electrode assembly 110 in different directions.

An electrode assembly 110 may include a separator 113. A separator 113 may be configured to prevent an electrical short-circuit between an anode sheet 111 and a cathode sheet 112 and to generate a flow of ions. According to an embodiment, a separator may include a porous polymer film or a porous nonwoven fabric. Here, a porous polymer film may consist of a single layer or multiple layers including a polyolefin-based polymer such as an ethylene polymer, a propylene polymer, an ethylene/butene copolymer, an ethylene/hexene copolymer, and an ethylene/methacrylate copolymer. A porous nonwoven fabric may include glass fibers of a high melting point and polyethylene terephthalate fibers. However, it is not limited to thereto, and according to embodiments, a separator may be a highly heat-resistant separator including ceramic (ceramic coated separator; CCS).

An electrode assembly 110 may be formed by stacking one or more cathode sheets 111, one or more anode sheets 112, and one or more separators 113 and then winding the same. When one or more cathode sheets 111, one or more anode sheets 112, and one or more separators 113 are stacked, the separators 113 may be positioned between a cathode sheet 111 and an anode sheet 112.

FIG. 3 shows a diagram for explaining a cap included in the secondary battery of FIG. 1.

Referring to FIG. 3, a cap 300 may include a cap plate 310 coupled to an open end of a pouch exterior material. A cap plate 310 may seal a pouch exterior material by being coupled to an open end of the pouch exterior material.

On a cap plate 310, an electrode terminal 320 electrically connected to either a cathode tab or an anode tab may be installed. In an embodiment, an electrode terminal 320 may be a cathode terminal electrically connected to a cathode electrode tab or an anode terminal electrically connected to an anode tab.

In one embodiment, both a cathode terminal and an anode terminal may be installed on a single cap 300, and in another embodiment, a cathode terminal and an anode terminal may each be installed on different caps 300.

In addition, a gas outlet 330 may be formed on a cap plate 310 to discharge a gas generated inside a secondary battery to the outside. For example, when the pressure inside a secondary battery increases due to an overload of an electrode assembly 110 accommodated in a pouch exterior material, the gas may be discharged to the outside through a gas outlet 330 to prevent explosion.

In addition, an inlet 340 through which an electrolyte may be injected into a secondary battery may be formed on a cap plate 310. An inlet 340 may be sealed after an electrolyte is injected into a secondary battery. An electrolyte may be a non-aqueous electrolyte. An electrolyte may include a lithium salt and an organic solvent. The organic solvent may include at least one of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

In an embodiment, a cap 300 may seal the inside of a pouch exterior material after a cap plate 310 is coupled to an open end of the pouch exterior material. In one embodiment, the inside of a pouch exterior material may be sealed by placing an adhesive at a portion where a cap 300 and a pouch exterior material are joined. An adhesive may include one or more of, for example, a silicone-based resin, a polyamide-based resin, a polyimide-based resin, an epoxy-based resin, and an acrylic resin, but it is not limited thereto. In another embodiment, that the inside of a pouch exterior material may be sealed by performing welding on a portion where a cap 300 and a pouch exterior material are joined.

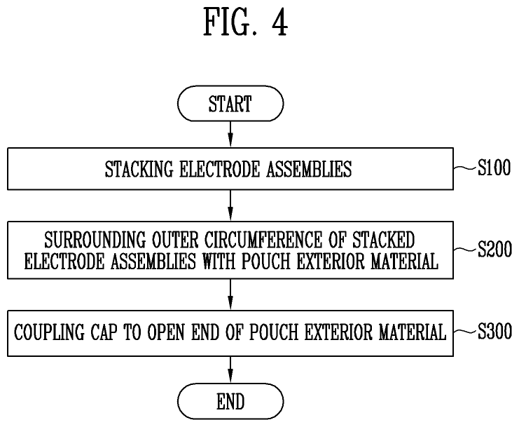

FIG. 4 shows a flowchart for explaining a manufacturing method of a secondary battery according to an embodiment of the present disclosure.

Referring to FIGS. 1 and 4, a manufacturing method of secondary battery according to an embodiment of the present disclosure includes S100 operation of stacking a plurality of electrode assemblies 110. Each electrode assembly 110 is a jelly roll-type electrode assembly. An electrode assembly 110 may be formed by stacking one or more cathode sheets, one or more separators, and one or more anode sheets, and then winding the same.

Next, the manufacturing method of secondary battery according to an embodiment of the present disclosure includes S200 operation of surrounding the outer circumference of stacked electrode assemblies 110 with a pouch exterior material 200. After performing S200 operation, one or more of an end of a pouch exterior material 200 in a direction in which a cathode tab protrudes and an end in a direction in which an anode tab protrudes may be opened.

Next, the manufacturing method of secondary battery according to an embodiment of the present disclosure includes S300 operation of coupling a cap 300 to an open end of a pouch exterior material 200.

In addition, the manufacturing method of secondary battery according to an embodiment inlet formed in a cap 300 after S300 operation.

FIG. 5 shows a diagram for explaining S100 operation of FIG. 4.

Referring to FIG. 5, a cell assembly 100 may be formed by stacking a plurality of jelly roll-type electrode assemblies 110. Stacked electrode assemblies 110 may be coupled to each other through a coupling member 120.

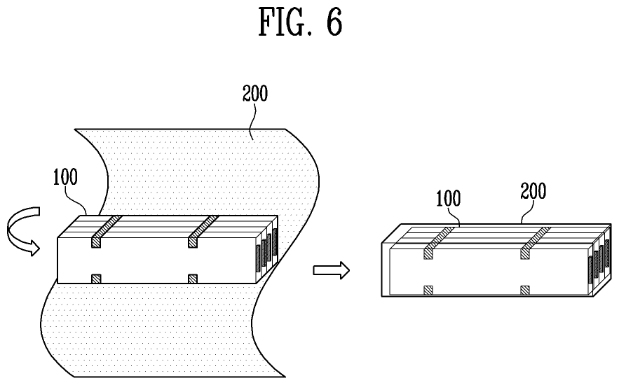

FIG. 6 shows a diagram for explaining S200 operation of FIG. 4.

Referring to FIG. 6, the outer circumference of the cell assembly 100 may be surrounded by a pouch exterior material 200. In an embodiment, the outer periphery of a cell assembly 100 may be surrounded by winding a pouch exterior material 200. Accordingly, a cell assembly 100 may be accommodated in a pouch exterior material 200.

Here, at least one end of a pouch exterior material 200 in which a cell assembly 100 is accommodated may be open. In one embodiment, an end of a pouch exterior material 200 may be open in one or more of a direction in which a cathode tab of a cell assembly 100 protrudes or a direction in which an anode tab protrudes.

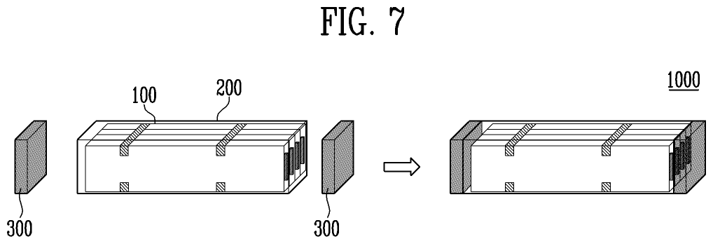

FIG. 7 shows a diagram for explaining S300 operation of FIG. 4.

Referring to FIG. 7, a cap 300 may be coupled to an open end of a pouch exterior material 200.

FIG. 7 shows that two ends of a pouch exterior material 200 are open and thus two caps 300 are coupled to the two ends of the pouch exterior material 200, but they are not limited thereto.

In another embodiment, when only one end of a pouch exterior material 200 is open, only one cap 300 may be coupled to the single open end of the pouch exterior material 200.

In an embodiment, a cap 300 may include: an electrode terminal electrically connected to one of a cathode tab and an anode tab; a gas outlet formed to discharge a gas generated from the inside of a secondary battery 1000; and an inlet formed to inject an electrolyte into a secondary battery 1000.

In one embodiment, a plurality of caps 300 may each include an electrode terminal, a gas outlet, and an inlet, and in another embodiment, one or more of an electrode terminal, a gas outlet, and an inlet may be formed in only some of a plurality of caps 300.

In an embodiment, a cap 300 may be coupled to a pouch exterior material 200 and then seal the inside of the pouch exterior material 200. To this end, in one embodiment, an adhesive may be position at a part where a cap 300 and a pouch exterior material 200 are coupled, and in another embodiment, welding may also be performed at a part where a cap 300 and a pouch exterior material 200 are coupled.

After a cap 300 seals the inside of a pouch exterior material 200, an electrolyte may be injected into a secondary battery 1000 through an inlet formed in the cap. Accordingly, electrode assemblies of a cell assembly 100 accommodated in a pouch exterior material 200 may be impregnated with an electrolyte.

What is claimed is:

1. A secondary battery comprising:
a cell assembly in which a plurality of electrode assemblies in which a cathode sheet, a separator, and an anode sheet are wound together are stacked; and
a pouch exterior material formed to surround the outer circumference of the cell assembly.

2. The secondary battery according to claim 1, wherein the electrode assembly is a jelly roll-type electrode assembly.

3. The secondary battery according to claim 1, wherein the electrode assembly includes: a cathode tab electrically connected to the cathode sheet and protruding from the electrode assembly; and an anode tab electrically connected to the anode sheet and protruding from the electrode assembly.

4. The secondary battery according to claim 3, wherein the cathode tab and the anode tab protrude from the electrode assembly in opposite directions.

5. The secondary battery according to claim 3, wherein the cathode tab and the anode tab protrude from the electrode assembly in same directions.

6. The secondary battery according to claim 3, wherein the cell assembly includes a plurality of electrode assemblies stacked in a direction perpendicular to the direction in which the cathode tab or the anode tab protrudes.

7. The secondary battery according to claim 6, wherein at least one of an end of the pouch exterior material in a direction in which the cathode tab protrudes and an end of the pouch exterior material in a direction in which the anode tab protrudes may be open.

8. The secondary battery according to claim 7, further comprising a cap coupled to an open end of the pouch exterior material.

9. The secondary battery according to claim 8, wherein the cap includes an electrode terminal electrically connected to any one of the cathode tab and the anode tab.

10. The secondary battery according to claim 8, wherein the cap includes a gas outlet formed to discharge a gas generated from the inside of the secondary battery.

11. The secondary battery according to claim 8, wherein the cap includes an inlet formed to inject an electrolyte into the secondary battery.

12. The secondary battery according to claim 1, wherein the cell assembly includes a coupling member that couples stacked electrode assemblies to each other.

13. The secondary battery according to claim 1, wherein the cell assembly includes three or more stacked electrode assemblies.

14. The secondary battery according to claim 12, wherein the coupling member includes an insulating material.

15. A manufacturing method of secondary battery, comprising:
a step of stacking a plurality of jelly roll-type electrode assemblies; and
a step of surrounding the outer circumference of stacked electrode assemblies with a pouch exterior material.

16. The manufacturing method of secondary battery according to claim 15, wherein the electrode assembly is formed by stacking a cathode sheet, a separator, and an anode sheet, and then winding the same.

17. The manufacturing method of secondary battery according to claim 15, further comprising: a step of coupling a cap to an open end of the pouch exterior material.
